(19) United States
(12) Patent Application Publication
(10) Pub. No.: US 2012/0209724 A1
(43) Pub. Date: Aug. 16, 2012

(54) System of incentive-based digital content and information sharing platform through mobile technology

(76) Inventor: David Wayne, San Diego, CA (US)

(21) Appl. No.: 13/373,856

(22) Filed: Dec. 2, 2011

Related U.S. Application Data
(60) Provisional application No. 61/458,897, filed on Dec. 3, 2010.
(60) Provisional application No. 61/460,036, filed on Dec. 23, 2010.

(51) Int. Cl. G06Q 30/02

(52) U.S. Cl. 705/14.72; 705/14.4

(57) ABSTRACT

A system of incentive-based digital content and information sharing platform through social media includes a software platform which contains an application that is downloadable to an electronic device of a user, allowing users to receive digital content from a central backend system that is built as a SaaS platform, namely the Promotions Management Panel. The Promotions Management Panel is arranged for pushing a digital content to different users and inducing the user to share the digital content through the user's social network by providing an incentive to reward the user, which includes a promotions tab serving as the home-screen; a statistics tab showing the users who have downloaded the promotional software; a reports tab serving as a dashboard for providing and displaying statistical information of a particular piece of digital content; and a rewards tab for creating a reward.

### CROSS REFERENCE OF RELATED APPLICATION

This is a regular non-provisional application that claims the benefit of priority under 35 U.S.C. §119 to a provisional application No. 61/458,897, which was filed on Dec. 3, 2010, and a provisional application No. 61/460,036 which was filed on Dec. 23, 2010.

### BACKGROUND OF THE PRESENT INVENTION

1. Field of Invention

The present invention relates to a system of incentive-based digital content and information sharing platform through social media, and more particularly to a business method of promotion which makes use of a promotional platform and an application which is downloadable to an electronic device, such as mobile phones, handheld devices, tablets, PCs, Macs and the like such that a digital content or information can be transmitted to the electronic device and spread through the electronic device to a social network through a social media connector.

2. Description of Related Arts

The growth of social media has provided a golden opportunity for business development and marketing. It is possible for a business entity to deliver a piece of content or information such as a promotional item through an existing community. However, it is a one-way unidirectional process only. There exists no business method or system which allows multi-level users to share a piece of content or information through leveraging an existing social media community.

Another problem is that the effectiveness of using a social media for a promotional item cannot be managed in any way. The massive content or information in an existing social media community which are important data for a business entity is left unattended. There exists no management platform to manage the content or information of a business entity for the promotional in response to market conditions.

Another problem is that there is no incentive for a user to share a promotion using his or her existing social media community. There is no existing method to optimize the use of user initiated sharing through the user's existing network.

### SUMMARY OF THE PRESENT INVENTION

The invention is advantageous in that it provides businesses, organizations, agencies and individual users a method of promoting a piece of digital content through leveraging a branded mobile application with connectors to multiple existing Social Media communities as a conduit for sharing that piece of content. The method employs an application through providing software on an electronic device. The software does this by providing a back end SaaS platform for the primary user of the software to input the digital content that they wish to share with their Consumers and ultimately through Social Media, it provides a mechanism to reach Consumers present in the existing Social Media community to receive that content through the use and download of an application that can be either on a mobile device, a tablet device or downloaded to a browser. The application provides the application users with a channel to share that content to their individual Social Media Networks. The application also provides its users incentives for sharing a piece of content to their Social Media networks by giving them rewards for each piece of content shared.

Another advantage of the invention is to provide a software platform which offers the central user an entire backend system that provides reports and analytics on number of application opens, content views and content shares. This allows the central user to directly view the effectiveness and response levels to each piece of digital content that is uploaded into the platform. The platform also offers a number of customizable features which allow the central user to differ the look and feel of the digital content that they are uploading into the Platform, determine the incentive awarded for sharing of the digital content and duration of time with which digital content can be shared.

Another advantage of the invention is to provide a system and method of delivering an incentive-based digital content and information through social media, in which the incentive-based digital content and information is pushed to users.

Another advantage of the invention is to provide a system of software platform, adapted for communicating with an electronic device through an application installed on the electronic device, so as to spreading an incentive-based digital content and information through the electronic device of a user using the user's existing network.

Another advantage of the invention is to provide a system with a software platform, adapted for communicating with an electronic device through an application installed on the electronic device for delivering an incentive-based digital content and information, wherein the system comprises one or more management tab units providing statistical analysis and reports, as well as customized flexibilities.

Additional advantages and features of the invention will become apparent from the description which follows, and may be realized by means of the instrumentalities and combinations particular point out in the appended claims.

According to the present invention, the foregoing and other objects and advantages are attained by a system of incentive-based digital content and information sharing platform through social media, comprising a software platform acting as a promotional software for business, which is adapted for downloading and installing to a mobile operating system of a mobile electronic device, comprising: a promotions management panel which is arranged for uploading a digital content and pushing the digital content to the mobile electronic device; wherein the promotions management panel comprises a promotions tab serving as the home-screen; a statistics tab showing the users who have downloaded the promotional software; a reports tab serving as a dashboard providing and displaying statistical information of a particular piece of digital content; and a rewards tab which is arranged for creating a reward that can be pushed to the mobile electronic device through the software platform.

In accordance with another aspect of the invention, the present invention is a system of delivering an incentive-based digital content, comprising:

a promotions management panel constructed through a computer serving as a central control panel, adapted for communicating with an electronic device through an application installed on the electronic device, wherein the promotions management panel comprises a plurality of management tabs such that the incentive-based digital content can be monitored, modified and promoted through the system of the present invention.

Preferably, the management tabs include a promotions tab for creating and modifying an incentive-based digital content which contains promotion and reward information of the incentive-based digital content; a statistics tab for providing statistical information associated with a particular incentive-based digital content; a reports tab graphically representing the statistical information in graphical form; and a rewards tab for creating a reward program for a particular incentive-based digital content and subsequent modification.

In accordance with another aspect of the invention, the present invention is a method of business promotion through social media, comprising the step of:

creating an incentive-based digital content through a promotions management panel of a system, wherein the promotions management panel is adapted for communicating with an electronic device through an application installed on the electronic device and comprising a plurality of management tabs in the promotions management panel;

pushing the incentive-based digital content through the system to the electronic device communicating with the system; and

providing a reward to the electronic device through which the incentive-based digital content is shared on social media at a preset level.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an exemplary illustration of a software platform as executed for a company running a promotion through user's mobile platforms in which the incentive for users to share the digital content is the awarding of loyalty rewards points according to a preferred embodiment of the present invention.

FIG. 2 depicts the home screen on the Promotions Tab in the Promotions Management Panel according to the above preferred embodiment of the present invention.

FIG. 3 depicts the Statistics Tab in the Promotions Management Panel according to the above preferred embodiment of the present invention.

FIG. 4 depicts the Report Tab in the Promotions Management Panel according to the above preferred embodiment of the present invention.

FIG. 5 depicts the Rewards Tab in the Promotions Management Panel according to the above preferred embodiment of the present invention.

FIG. 6 is an exemplary illustration of the Introductory Screen on the application in which all of the available pieces of content that an application user can share to their Social Media network(s) are depicted according to the above preferred embodiment of the present invention.

FIG. 7 is an exemplary illustration of the Promotion Screen on the application, which is the interface screen with which application users can share content that they receive to their Social Media network(s) according to the above preferred embodiment of the present invention.

FIG. 8 is an exemplary illustration of the Sharing Options Screen, which is a simple toggle interface which allows users to choose the Social Media network(s) to which they push digital content that they receive from the Promotions Management Pane according to the above preferred embodiment of the present invention.

FIG. 9 is an exemplary illustration which depicts an actual promotion shared to a Facebook wall according to the above preferred embodiment of the present invention.

FIG. 10 is an illustration of the system of according to the above preferred embodiment of the present invention.

### DETAILED DESCRIPTION OF THE PREFERRED EMBODIMENT

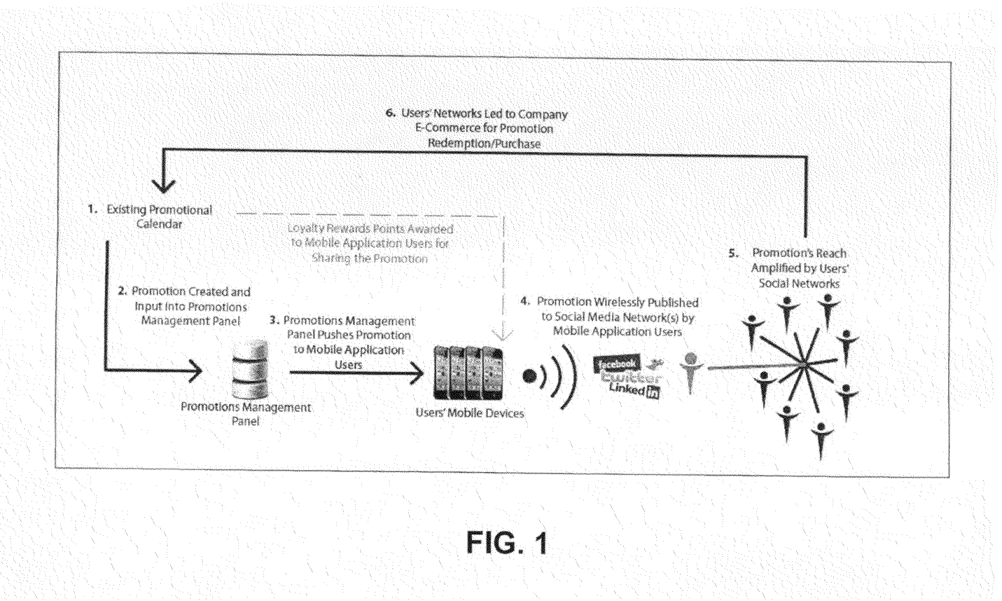

Referring to FIG. 1 of the drawings, the present invention is a system of incentive-based digital content and information sharing platform through social media.

The system of the present invention includes a software platform that acts as promotional software for businesses. The software contains an application that is downloadable to mobile operating systems, tablets, PCs, Macs and other operating systems alike. The application allows users to receive digital content from a central backend system that is built as a SaaS platform. A single party accesses and manages the backend SaaS platform, called the Promotions Management Panel, which could be a business, organization, agency or individual user. The operating party of the SaaS platform has the ability to upload digital content into the system that can be pushed to all users who have downloaded the application.

Users of the application have the option to customize the content that they receive from the SaaS platform and push it to their Social Media network(s). Some typical types of digital content that can be pushed to Social Media include but are not limited to, promotions, text-based messages, images, audio and videos.

Users are provided an incentive to share this content to their Social Media assets. Such incentives include but are not limited to loyalty points, rewards points, discounts on products, coupons, memberships and giveaways. When digital content is shared to the application user's Social Media platform, the incentive is then awarded to that user through the Promotions Management Panel.

The intent of sharing digital content to Social Media is to utilize the user's existing Social Media network to gain exposure for that digital content. In the case of a business utilizing this software, a user would share information or a promotion for a specific product or company initiative, and members of the user's Social Media network would then be exposed to that content resulting in an impression as in traditional advertising. The more members of the user's Social Media community that engage with the digital content that is shared to the user's Social Media assets, the greater the exposure given to that piece of digital content, and the higher the likelihood that the content goes “viral.” An example of this software platform as executed for a company running a promotion through user's mobile platforms is illustrated in FIG. 1 of the drawings. In this example, the incentive for users to share the digital content is the awarding of loyalty rewards points.

It is worth mentioning that this application provides businesses, organizations, agencies and individual users a method of promoting a piece of digital content through leveraging an existing Social Media community as a conduit for sharing that piece of content The software does this by providing a back end SaaS platform for the primary user of the software to input the digital content that they wish to share through Social Media, it provides a mechanism to reach people present in the existing Social Media community to receive that content through the use and download of an application that can be either on a mobile device, a tablet device or downloaded to a browser. The application provides the application users with a channel to share that content to their individual Social Media Networks. The application also provides its users incentives for sharing a piece of content to their Social Media networks by giving them rewards for each piece of content shared.

The software platform offers the central user an entire backend system that provides reports and analytics on number of application opens, content views and content shares. This allows the central user to directly view the effectiveness and response levels to each piece of digital content that is uploaded into the Promotions Management Panel. The Promotions Management Panel also offers a number of customizable features which allow the central user to differ the look and feel of the digital content that they are uploading into the Promotions Management Panel, determine the incentive awarded for sharing of the digital content and duration of time with which digital content can be shared.

Uses of the Invention

The application can be used in a number of various disciplines. One use is for businesses to have a low-cost marketing channel through Social Media that leverages existing members of a Social Media community as a brand ambassador for a specific product or promotion. In this instance, a business will input a promotional calendar into the Promotions Management Panel and share these promotions with all users who have downloaded the application. From this point, users of the application can share these promotions to their individual Social Media networks in exchange for loyalty points, rewards points or some other form of gift, giveaway or discount. The business will then gain exposure for their product on an average of a 1:200 multiple, as the average Social Media user has approximately 200 connections across their Social Media accounts.

If members of the application user's Social Media community begin to engage with the promotion that has been shared on Social Media, then this exposure figure grows exponentially. Each promotion is designed to link to a specific landing page or e-commerce platform. With this, people who are exposed to the promotion can click through to a purchase site directly from the Social Media asset in which they are viewing the promotion. Because of this, the time from impression to transaction is drastically reduced when compared to many other forms and channels of marketing and promotion.

Due to the fact that many users of the application will not share a promotion without getting something in return, an incentive system is necessary in order to optimize the effectiveness of the platform. Ideally, the platform will integrate into a business' loyalty, rewards or referral program, in which case users of the application will be awarded loyalty or rewards points for sharing a promotion. The application user can place a tangible value on these rewards points, and will be aware of the value sharing the promotion provides to them.

The central user of the platform of the present invention has access to the backend analytics that exist within the SaaS backbone. This will allow the central user to gauge the effectiveness of their promotions and the responsiveness of the application user community. In response to this, the central user will have the ability to adjust their rewards levels, look of promotions, items they promote and language used in the promotion to optimize the probability of having an application user share the promotion.

In other words, the present invention is a system of delivering an incentive-based digital content, comprising a promotions management panel 20, adapted for communicating with an electronic device through an application 40 installed on the electronic device. The promotions management panel 20 comprises a plurality of management tabs 21 in the promotions management panel 20. The management tabs 21 includes a promotion tab 211, a statistics tab 212, a report tab 213 and a reward tab 214.

The Promotions Management Panel

The Promotions Management Panel 20 is the hub for the central user to input digital content into the software platform of the present invention. This allows the user to create new content, deactivate old content, view analytics and reports, alter the settings of the content to be promoted and set up a rewards list for incentives to be given to people sharing the content. This Panel also allows the central user to see which devices have downloaded the application, and how active the users who downloaded are. The entire Promotions Management Panel exists in the cloud and is built as a SaaS platform in Ruby on Rails.

In other words, the promotions management panel 20 is the control platform of the system of the present invention. In particular, the promotions management panel 20 is constructed as a SaaS platform through a computer 10.

Promotions Tab

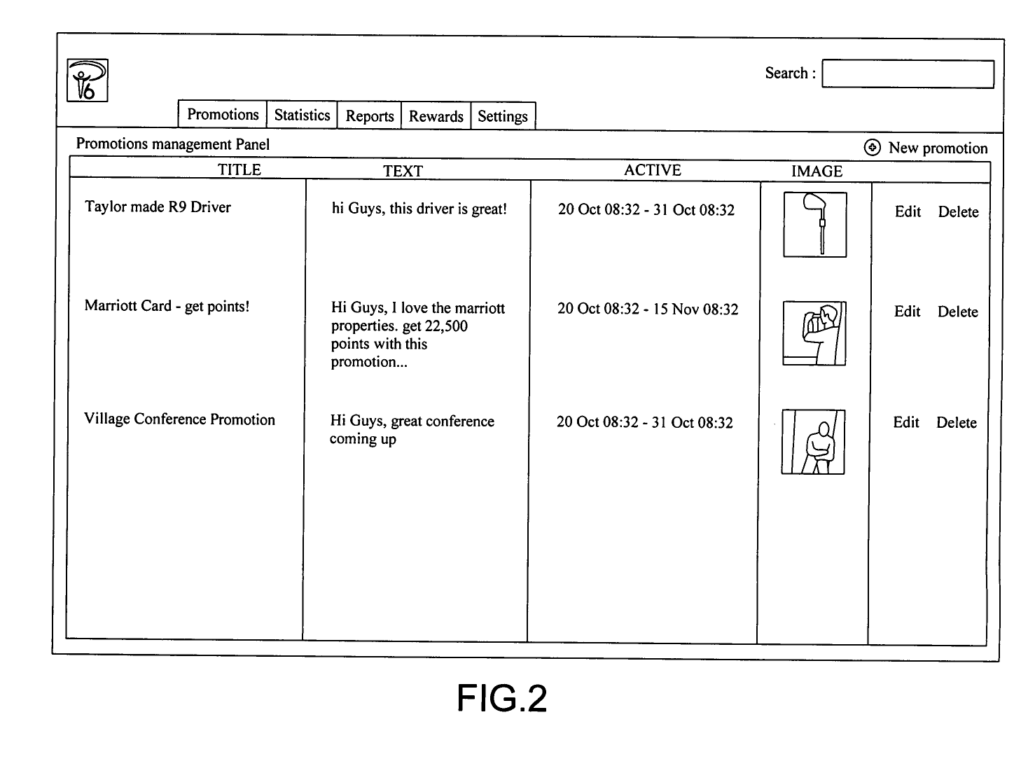

The Promotions tab provides the home-screen in the Promotions Management Panel. This tab allows users to create new digital content to be shared with all users who have downloaded the mobile application. A list of existing digital content that has been created is displayed on the home screen. The existing digital content shows the title of the content, any text that accompanies the content, the active dates allowed for content sharing, and images that accompany the content and an option to edit or delete the digital content. This provides the central user with an overarching view of the content that is being shared to all the users who have downloaded the application. The home screen on the Promotions Tab is illustrated in FIG. 2 of the drawings.

In this example, as shown in FIG. 2 of the drawings, the Promotions Management Panel is set up to run a text and imagery based promotion that can be shared with application users. Also in this example, users are given rewards points as an incentive for sharing the promotion to their Social Media network. When a central user clicks on “new promotion,” they have the ability to input a title for the promotion, the URL that they would like the promotion to link back to, any text that the central user wants to accompany the promotion, an image that can be attached to the promotion, the number of incentive “points” that the central user wants to award to the promotion and the dates for which they would like the promotion to be active.

In other words, the promotions tab 21 of the promotion management panel 20 allows entry or creation of an incentive-based digital content as a promotion associated with the promotion management panel 20, which is adapted for communicating to other electronic devices through the applications 40.

Preferably, referring to FIG. 2 of the drawings, the incentive-based digital content associated with the promotion management panel 20, which is the promotion, contains a title, a text description, an image and an active period of time. It is worth mentioning that the incentive-based digital content can be edited through the promotions tab 211 of the promotion management panel 20.

Statistics Tab

The Statistics Tab in the Promotions Management Panel shows, in list view, the users who have downloaded the application. Each user is assigned a unique ID, based on the device with which they have downloaded the application. This unique ID is customizable and can be assigned a text-based name if the central user so desires.

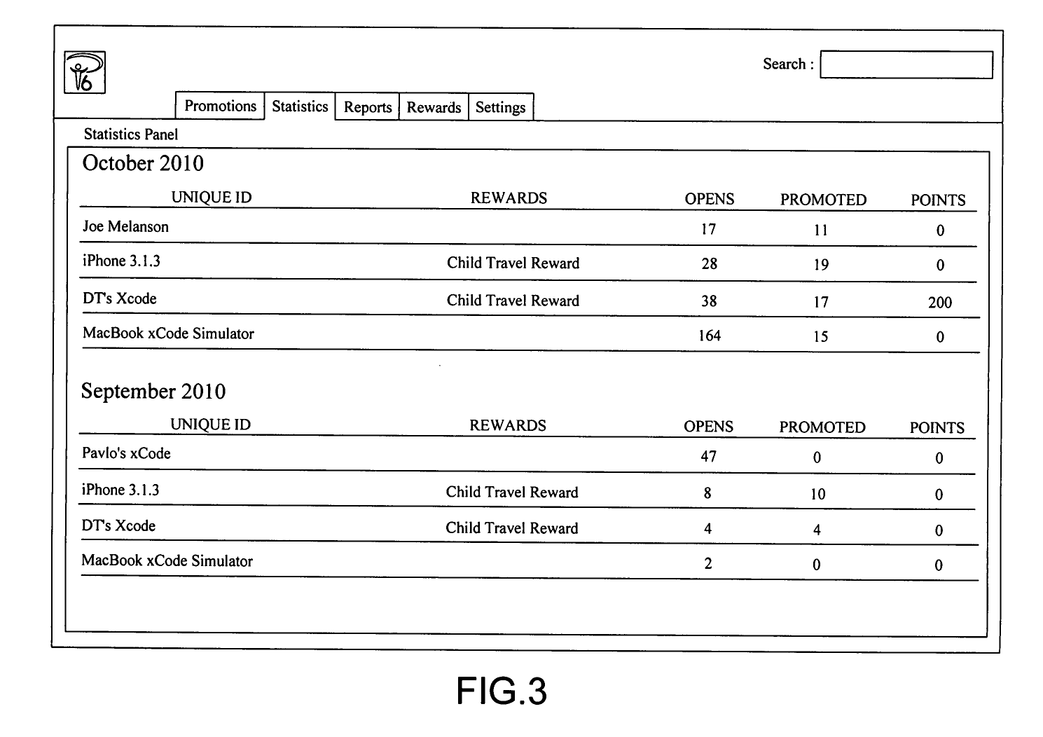

Also displayed is the Reward Level each user has achieved and the type of award they are entitled to. In this example, the reward level is based on the number of points accumulated for sharing content that has been pushed to their application. The Reward Levels are customizable and can be set in the Rewards Tab of the Promotions Management Panel. Also displayed on the Statistics Tab is the number of times each unique user of the application has opened the application in a given month, the number of times they have promoted a piece of digital content to their Social Media network(s) and the point totals that they have accumulated on a month-to-date basis. All unique user data is separated by months for easier data analysis. According to the preferred embodiment of the present invention, an exemplary illustration of the Statistics Tab is depicted in FIG. 3 of the drawings.

Referring to FIG. 3 of the drawings, the statistics tab 212 provides useful statistical information 2121 in relation to a particular promotion with each unique user. Accordingly, important statistical information 2121 in relation to the electronic device with which the application 40 is downloaded and installed, the number of times which the application 40 is opened, the number of times which the incentive-based digital content is promoted through the application 40 in a particular period of time are obtained. Therefore, a measurement of effectiveness of a particular promotion and reward can be quantified based on the statistical information 2121 in the statistics tab 212.

Reports Tab

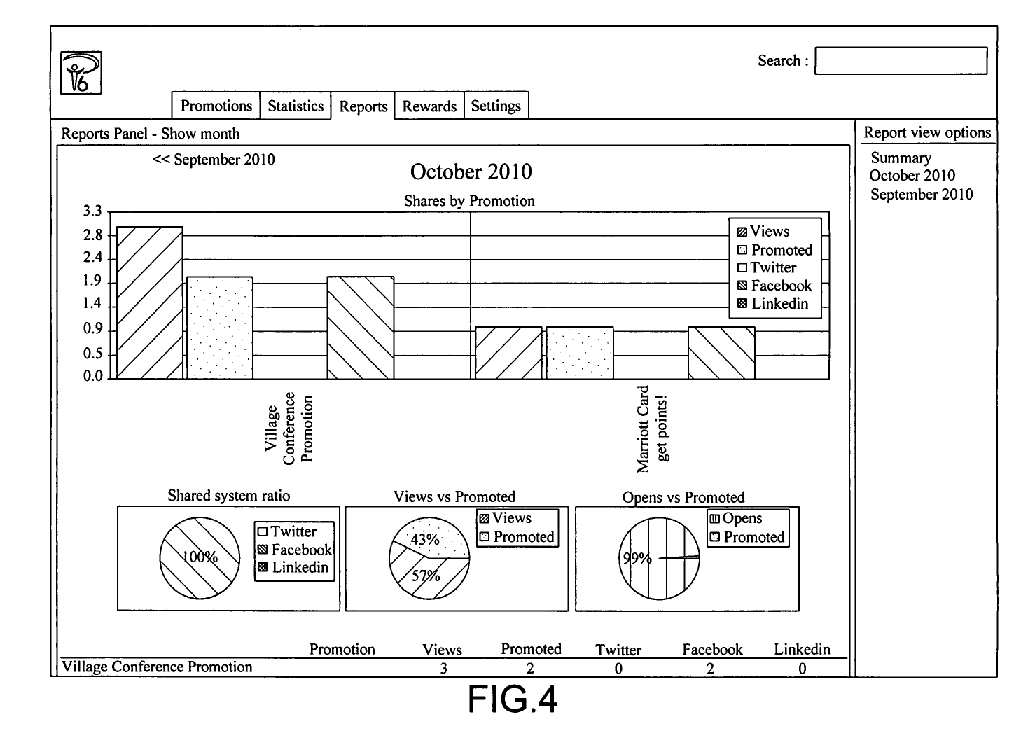

The Reports Tab in the Promotions Management Panel is a dashboard for statistics of users who have shared digital content through the use of the application. There is an overall summary graph, which shows the number of total views of a piece of content, the number of times that content has been shared and the platform(s) to which the content was shared in a given month. This is displayed as a graphical interface for easy data interpretation. Below the summary are three pie charts that are titled Shared System Ratio, Views vs. Promoted and Opens vs. Promoted. The Shared System Ratio displays which Social Media platforms application users are sharing content to and the ratio of shares to each. The Views vs. Promoted graph shows the percentage of views of a piece of content and the percentage of shares of that content as it relates to the number of times that it was viewed. The Opens vs. Promoted graph shows the percentage of times the application was opened and the percentage of shares of content as it pertains to each time the application was opened. This data is organized on a per-month basis so the central user can determine the impact of the content being shared and the level of engagement each application user has had with that content. According to the preferred embodiment of the present invention, an exemplary illustration of the Report Tab is depicted in FIG. 4 of the drawings.

Rewards Tab

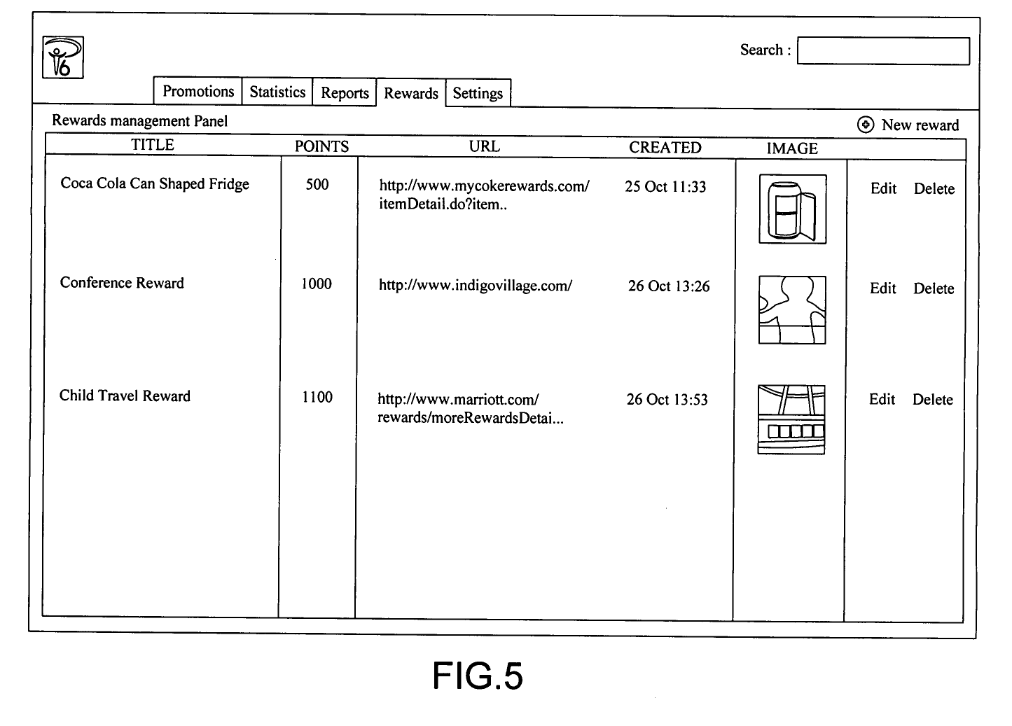

The Rewards Tab in the Promotions Management Panel allows the central user to create rewards that can be obtained by application users for sharing the digital content that is pushed to them. These rewards are based on users reaching a specific incentive level. This also is connected to the Statistics Page, which displays the Reward Level for each unique user of the application. The primary screen on the Rewards Tab displays the title of each available reward, the number of “points” or incentives required to obtain that specific reward, the date the reward was created and an associated image with the reward. There is also an option to edit or delete each individual reward. According to the preferred embodiment of the present invention, an exemplary illustration of the Rewards Tab is depicted in FIG. 5 of the drawings.

From this page, as shown in FIG. 5, the central user can create new rewards that can be given to application users once they reach a specific incentive level. In this specific example the reward is created by giving the reward a name, assigning the number of “points” required to redeem this particular reward, inputting the URL that links back to the reward for redemption and attaching an image to the reward.

In other words, the reward tab 214 contains reward information of one or more reward programs and allows the central user to edit the reward information. In particular, in response to the statistical information 2121 which quantified the effective of a particular promotion, the reward programs can be modified and edited, or a new reward program can be created through the reward tab 214.

The Application

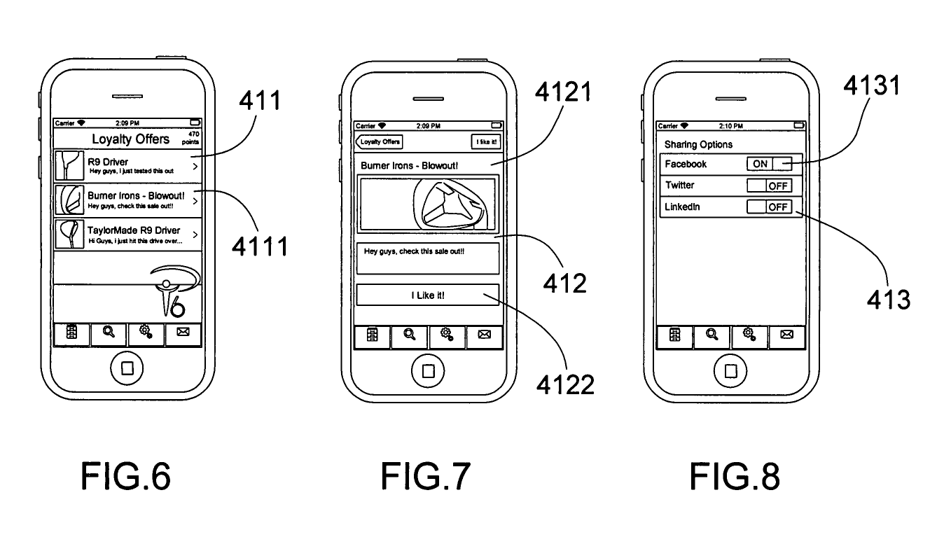

Referring to FIGS. 6 to 8 of the drawings, the application 40 in this particular example is depicted on an iPhone user interface as an illustrative example. The application 40 has been designed to work on multiple platforms including but not limited to the iPhone, iPad, Android, Blackberry OS and Windows Mobile. The application 40 is what the users download in order to view the digital content that is available to them via the Promotions Management Panel. The application can be branded and skinned for each individual central user as per their specifications.

The application 40 includes a plurality of application screens. Preferably, the application screens 41 include an introductory screen 411, a promotion screen 412 and a sharing option screen 413.

The digital content that is displayed in the application 40 is all content that can be shared to the user's Social Media network(s) when they choose to promote it. The application works similar to an email inbox, where all new content is displayed in hierarchical order from newest to oldest. From the applications, users can open specific pieces of content, they can view and share that content, they can customize the message that accompanies the content that they share and they can choose the Social Media platforms to which they share the content. The application also allows users to see their total incentive totals, which is displayed as rewards points in this example.

Introductory Screen

As shown in FIG. 6, the Introductory Screen on the application depicts all of the available pieces of content that an application user can share to their Social Media network(s). The content is depicted by the image, title and accompanying text that was input into the Promotions Management Panel by the central user. The application pulls the content via a wireless interne connection, broadband connection or data network available (depending on platform application is downloaded to). The application user's incentive total is also depicted on the top right side of the introductory screen.

Promotion Screen

Referring to FIG. 7 of the drawings, the Promotion Screen on the application is the interface screen with which application users can share content that they receive to their Social Media network(s). When an application user opens the promotions screen they are then presented with the digital content that was uploaded as the specific item that was input into the Promotions Management Panel by the central user. In this specific example a promotion for a product is displayed.

The application user views the image input into the Promotions Management Panel for that particular promotion. They are also presented with the text that accompanies that promotion, which can be customized and modified when viewed within the application, so the user can add their own language to the promotion. Lastly, there is an option for the application user to “like” the promotion, which, when clicked, will push and publish the promotion to the user's Social Media network(s). Users have the ability to choose which Social Media networks they publish the promotion to on the Settings screen.

Once a promotion is “liked” by an application user, they are then rewarded their incentive, which in this example is depicted by loyalty rewards points. Once a promotion is shared once, it is no longer available to the application user for a fixed period of time, which can be set by the central user of the Promotions Management Panel. Once the promotion is deactivated due to the application user sharing that promotion, the “Like” button will disappear for that fixed period of time; however, the application user will still have the ability to view the promotion from the application. This single-share feature has been implemented in order to prevent application users from spamming a single promotion in order to gain free rewards points.

Sharing Options Screen

As shown in FIG. 8 of the drawings, the Sharing Options Screen is a simple toggle interface, which allows users to choose the Social Media network(s) to which they push digital content that they receive from the Promotions Management Panel. Currently, this screen is configured for Facebook, Twitter and Linked In; however, it will be easily adjusted to share content across any Social Media network available today or in the future. When the application user turns to a Social Media network “On” any content that is “Liked” will be sent to that particular network. When a network is shown as “Off,” any content that is “Liked” will not be shared to that particular network, regardless of whether the application user has an account on that network or not. A single piece of content can be shared to multiple Social Media networks with one “Like.”

Sharing to Social Media: Facebook Example

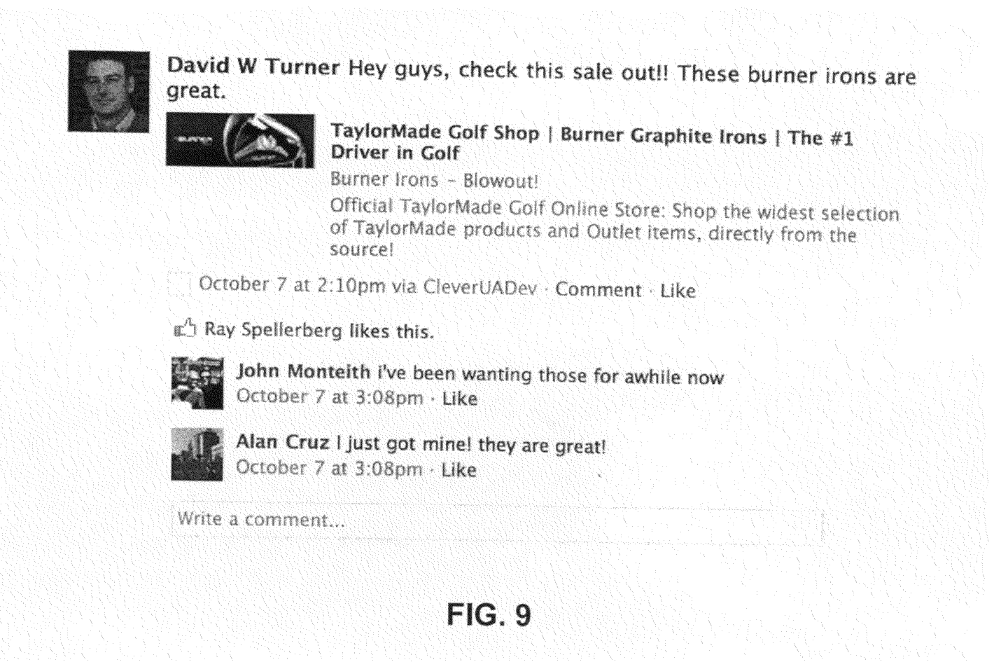

When a piece of content is shared to a Social Media network, it is displayed as a post that is consistent with the posting type for that particular network. The example as shown in FIG. 9 depicts an actual promotion shared to a Facebook wall. Similarly, the post would be depicted in a Tweet through Twitter, a Share through LinkedIn, and so on in the various networks activated.

Referring to FIG. 9 of the drawings, the above promotion has been posted to Facebook and is visible to all connections in the mobile application user's Social Media network. The application user has customized the text of the promotion, and the post contains a live link to an ecommerce platform, where people who view the promotion, can click through to purchase the item being promoted. This creates a direct path to creating a transaction and shortens the sales cycle when compared to other form of marketing and advertising.

Additionally, in this particular example, multiple connections in the application user's Social Media network have engaged with the promotion. Because of this, the promotion is now visible to all of the connections of the application user's connections that have engaged with the promotion. This illustrates the potential viral nature of any given piece of content that is shared from the application by a user. This is valuable to businesses, as they can potentially receive thousands of impressions for a particular piece of content by having one application user share that content. If this is expanded across a vast base of users who have downloaded the application and through multiple Social Media networks, a single piece of content can potentially receive millions of impressions through the use of this software platform.

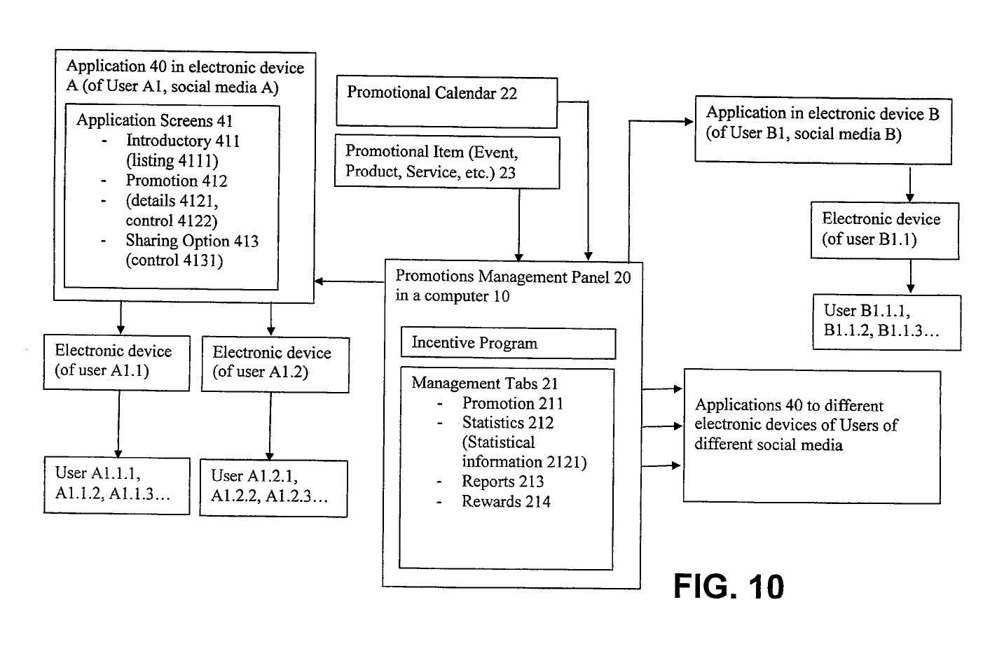

Accordingly, referring to FIG. 10 of the drawings, the present invention provides a system of delivering an incentive-based digital content, comprising a promotions management panel 20 constructed through a computer 10 serving as a central control panel, adapted for communicating with an electronic device through an application 40 installed on the electronic device, comprising a plurality of management tabs 21 in the promotions management panel 20 such that the incentive-based digital content can be monitored, modified and promoted through the system of the present invention.

The incentive-based digital content can be used to present a product item, a service item, an event or the like in the form of a text or an image.

Preferably, the management tabs 21 include a promotions tab 211, a statistics tab 212, a reports tab 213 and a rewards tab 214.

The promotions tab 211 is arranged for creating the incentive-based digital content which contains promotion and reward information of the incentive-based digital content. The promotions tab 211 is also arranged for modifying the incentive-based digital content after the incentive-based digital content is created through the promotions tab 211. Preferably, the promotion and reward information may include a title, a text description, a preset active time period and an image. It is worth mentioning that more than one incentive-based digital contents can be created and displayed through the promotions tab 211 of the system 20. Accordingly, a business entity can make use of the system to create different promotion programs to fit their needs.

The statistics tab 212 is arranged for providing statistical information associated with a particular incentive-based digital content. In particular, the statistical information includes the name of an electronic device with which the application 40 is downloaded and installed, the number of times which the application 40 is opened, and the number of times which the incentive-based digital content is promoted through the application 40 in a particular period of time. Therefore, a quantified measurement for each particular electronic device is generated and accessible through the statistical information. For example, a reward point scale based on the number of times which the incentive-based digital content is promoted through the application 40 in a particular period of time can be realized. In other words, the effectiveness of promotion through a particular incentive-based digital content can be quantified based on the statistical information 2121 in the statistics tab 212.

Preferably, the reports tab 213 is included to graphically representing the statistical information in graphical form, providing a quick reference to the user.

The rewards tab 214 is arranged for creating a reward program for a particular incentive-based digital content and subsequent modification. For example, a reward which is awarded based on number of reward points can be created and modified through the rewards tab 214. Preferably, multi-level reward can be created for a particular incentive-based digital content.

It is worth mentioning that a plurality of incentive-based digital contents can be created and stored in the promotions management panel 20 associated with a corresponding active time frame and reward. In other words, a plurality of incentive-based digital contents active in different time period can be inputted and stored in the system of the present invention such that a promotional calendar 22 containing different promotional items 23 (an event, a product, a service item, etc.) is generated. Accordingly, the system of the present invention provides an effective tool for business planning, facilitating a business entity to scheduling different promotional items 23 which is then pushed to the application users according to the promotional calendar 22.

The application 40, which is available and downloadable from the system of the present invention, is arranged for installing into an electronic device of an application user. The application 40 can be installed in multiple platforms, and is workable in a plurality of electronic devices such as iPhone, iPad, Android, Blackberry OS, Windows Mobile or the like.

Preferably, the application 40 provides a plurality of application screens 41 such that the incentive-based digital content can be shared through social media of the application user. In particular, the application screens 41 includes an introductory screen 411 containing a listing of the incentive-based digital content 4111, a promotion screen 412 containing details of a particular incentive-based digital content 4121 and a control unit 4122 for initiating the sharing of the particular incentive-based digital content 4121, and a sharing option screen 413 providing a listing of available social media for sharing the incentive-based digital content and a control 4131 switch under each of the available social media for setting the sharing option of the social media. For example, as shown in FIG. 8 of the drawings, the application user can choose to share the incentive-based digital content on facebook through switching on the sharing option of facebook.

Accordingly to another aspect of the present invention, a method of business promotion through social media is provided. The method comprises the steps of:

creating an incentive-based digital content through a promotions management panel of a system, wherein the promotions management panel is adapted for communicating with an electronic device through an application installed on the electronic device and comprising a plurality of management tabs in the promotions management panel;

pushing the incentive-based digital content through the system to the electronic device communicating with the system; and

providing a reward to the electronic device through which the incentive-based digital content is shared on social media at a preset level.

One skilled in the art will understand that the embodiment of the present invention as shown in the drawings and described above is exemplary only and not intended to be limiting.

Accordingly, the incentive-based digital content can be shared through a social media of the application user, which is motivated through the reward and in response to the pushing of the incentive-based digital content.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A system of delivering an incentive-based digital content, comprising:
a promotions management panel constructed through a computer serving as a central control panel;
an application communicating with said central control panel, arranged for installing onto an electronic device such that said promotions management panel is capable of communicating with the electronic device through said application; and
a plurality of management tabs contained in said promotions management panel and communicated to the electronic device,
thereby the incentive-based digital content is capable of being monitored, modified and promoted through said promotions management panel and delivered to the electronic device.

2. The system, as recited in claim 1, wherein the incentive-based digital content contains a product item, a service item or an event item which is displayed in the form of a text of an image in the electronic device.

3. The system, as recited in claim 1, wherein one of said plurality of management tabs is a promotions tab through which the incentive-based digital content is created and modified.

4. The system, as recited in claim 2, wherein one of said plurality of management tabs is a promotions tab through which the incentive-based digital content is created and modified.

5. The system, as recited in claim 4, wherein the incentive-based digital content contains a promotion and reward information and said promotion tab is arranged for creating and modifying the promotion and reward information of the incentive-based digital content, wherein the promotion and reward information includes at least a title, a text description, a preset active time period and an image.

6. The system, as recited in claim 4, wherein one of said plurality of management tabs is a statistics tab providing statistical information associated with a particular incentive-based digital content, wherein the statistical information includes a name of a particular electronic device with which the application is downloaded and installed, a number of times which the application is opened by the particular electronic device, and a number of times which the incentive-based digital content is promoted through the application of the particular electronic device in a particular period of time.

7. The system, as recited in claim 5, wherein one of said plurality of management tabs is a statistics tab providing statistical information associated with a particular incentive-based digital content, wherein the statistical information includes a name of a particular electronic device with which the application is downloaded and installed, a number of times which the application is opened by the particular electronic device, and a number of times which the incentive-based digital content is promoted through the application of the particular electronic device in a particular period of time.

8. The system, as recited in claim 4, wherein one of said plurality of management tabs is a reports tab which graphically presents the statistical information in graphical form so as to provide a quick reference to the user.

9. The system, as recited in claim 7, wherein one of said plurality of management tabs is a reports tab which graphically presents the statistical information in graphical form so as to provide a quick reference to the user.

10. The system, as recited in claim 5, wherein one of said plurality of management tabs is a rewards tab through which a reward program for a particular incentive-based digital content is created and modified.

11. The system, as recited in claim 7, wherein one of said plurality of management tabs is a rewards tab through which a reward program for a particular incentive-based digital content is created and modified.

12. The system, as recited in claim 7, wherein said application of the system is made available and downloadable through said central control panel and is workable in a plurality of platforms which includes both iOS and WINDOWS platforms.

13. A method of business promotion through social media, comprising the steps of:
(a) providing a system of delivering an incentive-based digital content which includes a promotions management panel;
(b) creating an incentive-based digital content through the promotions management panel of a system;
(c) providing an application to an electronic device and bridging the promotions management panel and the electronic device; and
(d) pushing the incentive-based digital content to the electronic device communicating through the promotions management panel of the system.

14. The method, as recited in claim 13, after step (d), further comprising the step of:
(d1) spreading the incentive-based digital content to other electronic devices on the electronic device through the electronic device communicating with social media.

15. The method, as recited in claim 13, after step (d), further comprising the step of:
(e) giving a reward generated from the system and communicating to the electronic device if the incentive-based digital content is shared on social media at a preset level through the particular electronic device.

16. The method, as recited in claim 14, after step (d1), further comprising the step of:
(e′) promoting the spreading of the incentive-based digital content through the social media by giving a reward generated from the system and communicating to the electronic device if the incentive-based digital content is shared on social media for a preset number of times through the particular electronic device.

17. The method, as recited in claim 16, wherein the incentive-based digital content contains a product item, a service item or an event item which is displayed in the form of a text of an image in the electronic device.

18. The method, as recited in claim 17, wherein said promotions management panel is a central control panel and said application is made available and downloadable through said central control panel and is workable in a plurality of platforms which includes at least both iOS and WINDOWS platforms.

19. The method, as recited in claim 18, wherein in step (c), further comprising the steps of:
(c1) providing a plurality of interfaces to the electronic device through the application, wherein each said interface is corresponding to a particular management tab of the central control panel, wherein said plurality of interfaces are arranged for displaying a promotions tab through which the incentive-based digital content can be created and modified, a statistics tab which provides statistical information associated with a particular incentive-based digital content, a reports tab which graphically presents the statistical information in graphical form, and a rewards tab through which a reward program for a particular incentive-based digital content is created and modified.

20. The method, as recited in claim 19, wherein in step (c), wherein said application is made available by the central control panel and is downloadable to the electronic device.
